(19) United States
(12) Patent Application Publication
(10) Pub. No.: US 2019/0147538 A1
(43) Pub. Date: May 16, 2019

(54) COGNITIVE APPROACH TO IDENTIFYING ENVIRONMENTAL RISK FROM INCOMPLETE TELEMATICS DATA AND CLAIM DATA

(71) Applicant: INTERNATIONAL BUSINESS MACHINES CORPORATION, ARMONK, NY (US)

(72) Inventors: NING DUAN, BEIJING (CN); PENG GAO, BEIJING (CN); GUO QIANG HU, SHANGHAI (CN); KAI LI, SHANGHAI (CN); ZHI HU WANG, BEIJING (CN); XIN ZHANG, BEIJING (CN)

(21) Appl. No.: 15/814,478

(22) Filed: Nov. 16, 2017

(51) Int. Cl. G06Q 40/08; G06F 17/30; H04L 29/08; G06F 15/18; G06F 17/18; G06K 9/62

(52) U.S. Cl. CPC G06Q 40/08; G06F 17/3053; G06K 9/626; G06F 15/18; G06F 17/18; H04L 67/306

(57) ABSTRACT

According to one embodiment, a method, computer system, and computer program product for cognitive digital risk analysis is provided. The present invention may include receiving telematics data; receiving road network and weather data; generating one or more customer behavior profiles based on the telematics data and the road network and weather data; receiving historical claims data; training, using the historical claims data and features of the customer behavior profile, a risk scoring engine; and producing, by the risk scoring engine, an assessment of the risk of loss posed by one or more drivers.

### BACKGROUND

The present invention relates, generally, to the field of computing, and more particularly to digital risk analysis.

Digital risk analysis involves the use of computers to determine a quantitative or qualitative risk estimate related to a well-defined situation and a recognized threat. Digital risk analysis is increasingly used by insurance carriers with the advent of better risk models and increasing availability of data. One area of insurance where digital risk analysis can be applied to particularly powerful effect is that of usage-based insurance, or UBI. UBI is a more data-intensive version of traditional insurance, and involves collecting large amounts of driving data from participating drivers, including type of vehicle used, time, distance, behavior, and place; from this data, an insurance carrier may use digital risk analysis to assess the driving behaviors of the driver, calculate the level of risk for each driver, and adjust each driver's insurance premiums accordingly. Furthermore, UBI is becoming a more attractive option to insurance carriers, as approaches other than discounting insurance premiums can help carriers target new customer segments and expand market share without sacrificing the bottom line. As consumer awareness in UBI grows, and UBI becomes a more and more attractive option to insurance carriers, there is an increasing need among insurance carriers to pursue improvements in digital risk assessment methods.

### SUMMARY

According to one embodiment, a method, computer system, and computer program product for cognitive digital risk analysis is provided. The present invention may include receiving telematics data; receiving road network and weather data; generating one or more customer behavior profiles based on the telematics data and the road network and weather data; receiving historical claims data; training, using the historical claims data and features of the customer behavior profile, a risk scoring engine; and producing, by the risk scoring engine, an assessment of the risk of loss posed by one or more drivers.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a cognitive risk assessment process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to digital risk analysis. The following described exemplary embodiments provide a system, method, and program product to, among other things, use telematics data from connected vehicles, as well as road network, weather, and historical claims data to derive a contextual customer profile representing customer behavior in a real world environment, and the risks associated with such behavior. Therefore, the present embodiment has the capacity to improve the technical field of digital risk analysis by allowing insurance carriers to better understand the risk faced by individual policy holders, in order to enable more accurate pricing and to enhance the claims process by fully accessing a deeper and broader data set.

As previously described, digital risk analysis involves the use of computers to determine a quantitative or qualitative risk estimate related to a well-defined situation and a recognized threat. Digital risk analysis is increasingly used by insurance carriers with the advent of better risk models and increasing availability of data. One area of insurance where digital risk analysis can be applied to particularly powerful effect is that of usage-based insurance, or UBI. UBI is a more data-intensive version of traditional insurance, and involves collecting large amounts of driving data from participating drivers, including type of vehicle used, time, distance, behavior, and place; from this data, an insurance carrier may use digital risk analysis to assess the driving behaviors of the driver, calculate the level of risk for each driver, and adjust each driver's insurance premiums accordingly. Furthermore, UBI is becoming a more attractive option to insurance carriers, as approaches other than discounting insurance premiums can help carriers target new customer segments and expand market share without sacrificing the bottom line. As consumer awareness in UBI grows, and UBI becomes a more and more attractive option to insurance carriers, there is an increasing need among insurance carriers to pursue improvements digital risk assessment methods.

In the field of digital risk assessment as it pertains to insurance, there are multiple types of data that insurance companies can use to assess risk. Claim data is the most prolific; claim data includes the information submitted along with insurance claims, such as make and model of the car, nature of the incident, damages incurred, conditions at the time of the incident, et cetera. However, while claim data is useful in making general assessments of risk, it suffers from the shortcoming that it only pertains to incidents that have already happened, and cannot be used to predict the risk incurred by any particular driver unless that driver has already been involved in some amount of incidents, and even then can only be used to make general assessments. Furthermore, claim data often requires supplemental information in order to be interpreted correctly; for example, if a major claim happens on a main road, this may not be because the main road is more dangerous, but because the main road has much more traffic. Another type of data available to insurance companies is telematics data, which is data collected from a car during its operation by a device installed within the car with consent of the driver. This device is much more limited, as the device used to collect the data may be costly, and drivers are often uncomfortable with allowing an insurance company a more intimate level of access to their driving habits. However, telematics data is also more useful as it contains more information than claim data, such as mileage, time, location, context of driving, driving behaviors, et cetera; this data can be used to assess the risk incurred by a driver before the driver has been involved in an incident. Using the telematics information can also allow the insurance company to determine the weather, road, and traffic conditions. However, insurance companies have found it difficult to synthesize both the claim data and the limited telematics data in a fashion that lets insurance companies draw useful inferences of risk. As such, it may be advantageous to, among other things, implement a system that allows an insurance company to leverage their large amounts of claim data and limited telematics data through a statistical approach that gives the normalization of a claim and provides the relative risk level and a boundary of confidence regarding that risk level.

According to one embodiment, the invention receives telematics data from the connected vehicles of a driver, which is then synthesized with road network and weather data, to generate a context-enriched driver behavior profile containing tens of thousands of data features representing the driver's behavior in the real world environment, including driving record, driving behavior, trajectory and footprint patterns. The invention further correlates the customer profile features with historical claims data. The customer profile features are then used to train a risk scoring engine to predict the likelihood that the driver will cause losses in the future, as well as a confidence level in the accuracy of this likelihood.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to use telematics data from connected vehicles, as well as road network, weather, and historical claims data to derive a contextual customer profile representing customer behavior in a real world environment, and the risks associated with such behavior.

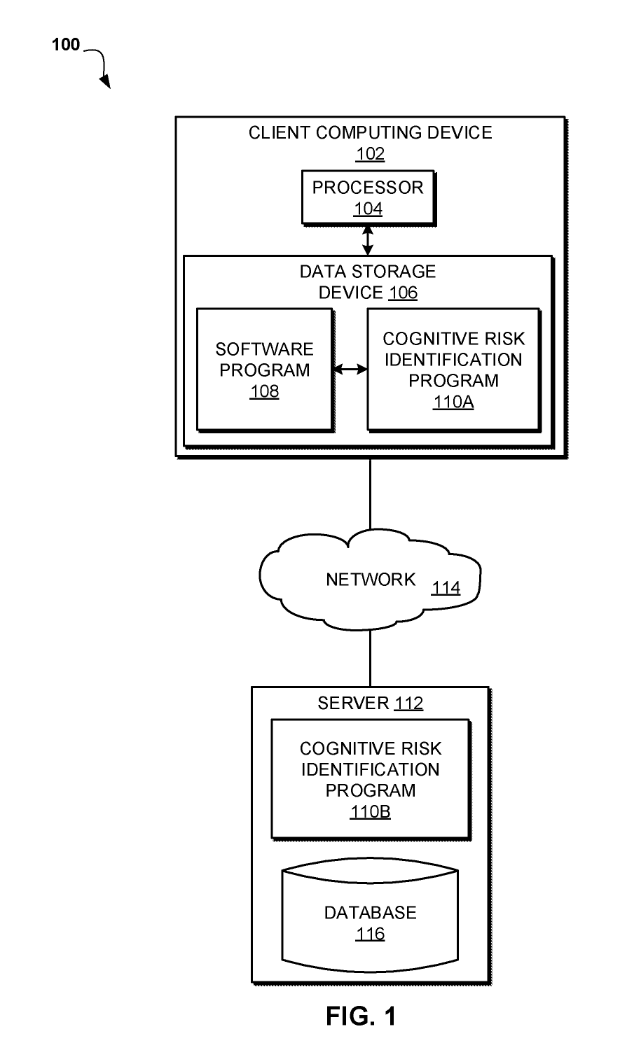

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

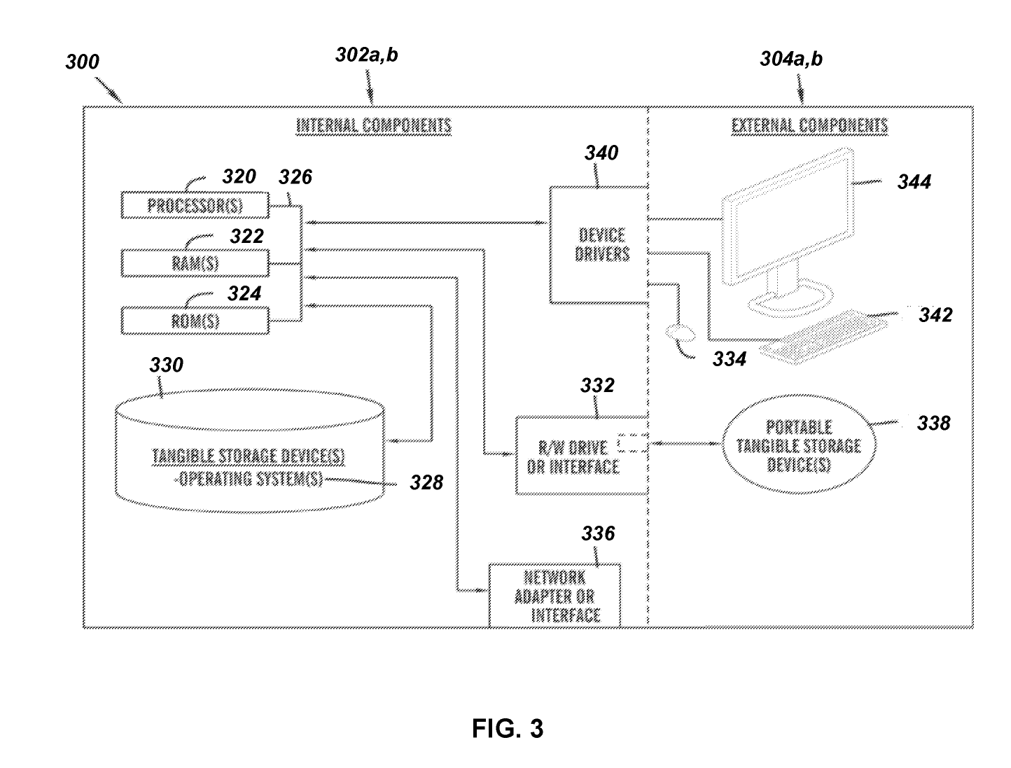

Client computing device 102 may include a processor 104 and a data storage device 106 that is enabled to host and run a software program 108 and a cognitive risk identification program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a cognitive risk identification program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

Software program 108 may represent any program or suite of programs that call or communicate with cognitive risk identification program 110A, 110B. Software program 108 may be a suite of insurance software programs that call cognitive risk identification program 110A, 110B as a module for providing risk assessments. In an alternate embodiment, software program 108 may be a database program that furnishes claim, weather, telematics, or any other data to cognitive risk identification program 110A, 110B. Software program 108 may be located anywhere within communication of the cognitive risk identification program 110A, 110B, such as on client computing device 102, server 112 or on any other device located within network 114. Furthermore, software program 108 may be distributed in its operation or location over multiple devices, such as client computing device 102 and server 112.

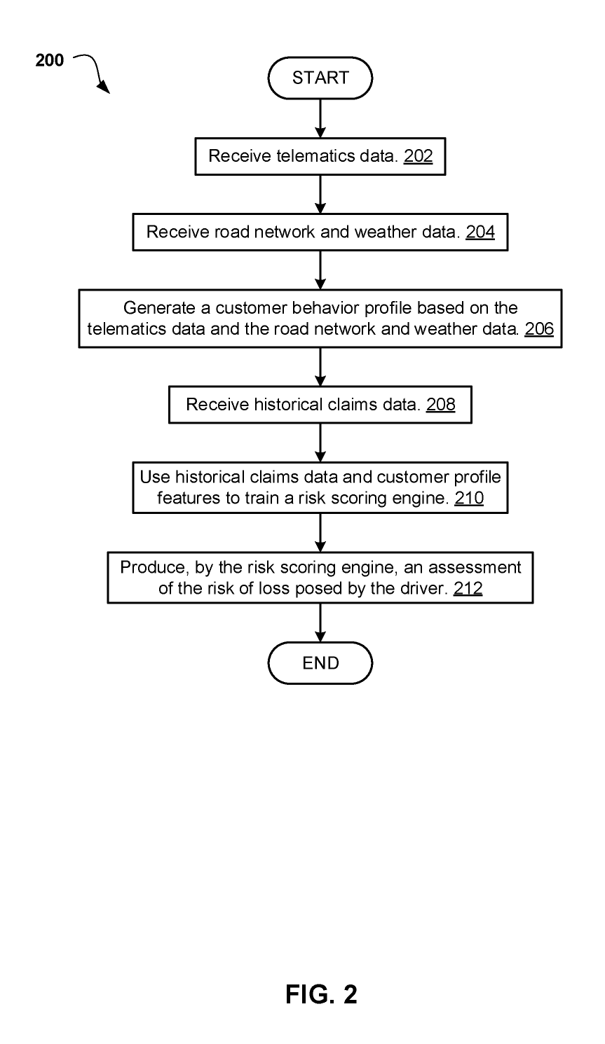

According to the present embodiment, the cognitive risk identification program 110A, 110B may be a program capable of use telematics data from connected vehicles, as well as road network, weather, and historical claims data to derive a contextual customer profile representing customer behavior in a real world environment, and the risks associated with such behavior. The cognitive risk assessment process 200 is explained in further detail below with respect to FIG. 2. The cognitive risk identification program 110A, 110B may be located on client computing device 102, server 112 or on any other device located within network 114. Furthermore, cognitive risk identification program 110A, 110B may be distributed in its operation or location over multiple devices, such as client computing device 102 and server 112.

Referring now to FIG. 2, an operational flowchart illustrating a cognitive risk assessment process 200 is depicted according to at least one embodiment. At 202, the cognitive risk identification program 110A, 110B receives telematics data. Telematics data is data gathered from a driver's car by a suite of sensors or instruments installed in the car. Telematics data may pertain to multiple drivers, not necessarily only the driver whose individual risk is being assessed. Events that affect driving risk, such as road accidents, are rare events; therefore, to evaluate such risk, data of a large number of drivers is necessary to achieve credible statistical conclusions, or the risk level under each type of context. Then, based on such general risk level of given driving contexts, the risk of individual driver can be evaluated by his/her risk exposure (driving mileage or driving time) under the driving contexts. The telematics data may comprise data on where a vehicle is, how fast the vehicle is traveling, how far a vehicle has traveled, how a vehicle is behaving internally, et cetera. This data may be received directly from sensors within the connected vehicle of a driver, may be received from a program such as software program 108, or may be retrieved by cognitive risk identification program 110A, 110B from a data repository in communication with cognitive risk identification program 110A, 110B, such as data storage device 106 or database 116.

Next, at 204, cognitive risk identification program 110A, 110B receives road network and weather data. The road network data is data that may pertain, respectively, to the physical state of the road including presence of potholes, width of the road, whether the road has a shoulder or guardrails, and elevation, as well as conditions on the road such as traffic, accidents, fallen trees, construction, road closures, oil slicks, et cetera. The weather data may be data pertaining to weather conditions that might be relevant to driving conditions, such as rain, ice, hail, high winds, fog, temperature, humidity, et cetera. The weather data may also include such conditions as sunset/sunrise, seasons, volcanic activity, smog, and wildfires. The road network and weather data may be received from a program, such as software program 108, or may be retrieved by cognitive risk identification program 110A, 110B from a data repository in communication with cognitive risk identification program 110A, 110B, such as data storage device 106 or database 116, or from a website or web service.

Then, at 206, cognitive risk identification program 110A, 110B generates a customer behavior profile based on the telematics data and the road network and weather data. The cognitive risk identification program 110A, 110B creates the customer behavior profile by using the road network and weather data to enrich the context of the telematics data, and using the context-enriched telematics data to extrapolate a driver's driving record, driving behavior, trajectory and footprint patterns. The customer profile may contain tens of thousands of data features representing the driver behavior in the real world environment. By itself, the telematics data gives an incomplete picture; for example, from the telematics data alone, one might see that a driver drives erratically on some stretches of road, and conclude that the driver is engaging in risky behavior. However, with the added context provided by the road network data, one might see that the driver's erratic driving is caused by potholes in the surface of the road, which require erratic driving patterns to negotiate safely. Therefore, the road network and weather data is necessary to correctly interpret the telematics data, and to generate an accurate customer behavior profile. The behavior profile may take any form that allows it to represent the driver's behavior in a real world environment; for example, the behavior profile may be a histogram of the driver's driving mileage or driving time over different driving contexts.

Next, at 208, cognitive risk identification program 110A, 110B receives historical claims data. The historical claims data may comprise data filed as part of an insurance claim in the past, such as driver name, policy number, make and model of the vehicle, date and time of the incident, personal data of drivers, passengers and witnesses, and other information relevant to an incident that is the subject of an insurance claim. The historical claims data may be received from a program, such as software program 108, or may be retrieved by cognitive risk identification program 110A, 110B from a data repository in communication with cognitive risk identification program 110A, 110B, such as data storage device 106 or database 116, or from a website or web service.

Then, at 210, cognitive risk identification program 110A, 110B uses the historical claims data and customer profile to train a risk scoring engine. The cognitive risk identification program 110A, 110B correlates the customer profile features with historical claims data to train a risk scoring engine to predict the likelihood for that driver to bring loss in the future. The risk scoring engine is a cognitive system that uses machine learning to improve the accuracy of its output as the amount or quality of available training data increases. The machine learning abilities of the system must be applied to a mathematical model to train the system initially; historical claim data and driving profiles of a large number of drivers may be applied to train the model. The risk scoring engine may employ any mathematical model capable of predicting a driving risk level of a driver based on his/her profile (e.g., driving time and mileage under different driving contexts). The present embodiment may employ a statistical linear regression model. One example of a suitable statistical linear regression model may be a Poisson probability distribution modeling the number of claims occurring over a period of time or mileage according to the following function:

$$Pr ( N ( [ {t}_{0} , {t}_{1} ] ) = k ) = \frac{{( λΔ t )}^{k}}{k !} {e}^{- ( λΔ t )}$$

where k is the claim number, delta-t is the driving duration or mileage, and lambda is the average claim number per unit of time or mileage (i.e., the claim occurrence rate). Mileage may be more desirable to use than time, as driving time can include the time period within which a vehicle does not move at all, which may distort the data. The lambda parameter under different context types may have different values due to the differing impacts of various contexts on the driving. Another a suitable statistical linear regression model may use the Poisson distribution to model the claim number for each policy year according to the following function:

$${p}_{k} = \frac{{e}^{- λ} {λ}^{k}}{k !} , k = 0 , 1 , 2 , . . . .$$

Here, lambda is the average claim number. Typically, policy holders will be categorized into several groups according to demographic features. For members in each group, the annual claim number follows a Poisson distribution with a group-specific average number of lambda. Other models besides statistical linear regression models may also be used, such as regression networks, classification networks of deep learning models, and classification models in machine learning technologies. In some embodiments, the cognitive risk identification program 110A, 110B may use the mathematical model to build a confidence level of driving context. The confidence level may be a measure of the credibility of the risk estimations from the historical data. It may depend on the both the probability nature of how often the risk comes true (i.e., the claim occurrence) and the level of risk exposure, namely, the total driving time or mileage of history data. For a rare event, for example, a large span of driving time or mileage is necessary to achieve a reliable assessment of the risk.

Next, at 212, the risk scoring engine produces an assessment of the risk of loss posed by the driver. This assessment produced may take the form of any mathematically determined representation of risk, and may differ depending on the model used; for example, in the case of a Poisson model, the engine will create a probability distribution for the number of claims that the driver can have. With a classification of machine learning, the engine may classify the user to a risk category (e.g., high/medium/low risk). In some embodiments, cognitive risk identification program 110A, 110B may represent risk through claim ratios in the risk assessment, where a claim ratio is the ratio of the number of claims to the total risk exposure (e.g., time or distance driven) under the specific driving context (e.g., rainy weather, driving out of a city, et cetera). The cognitive risk identification program 110A, 110B may produce the claim ratio by first building a normalized mileage model. The mileage model may be based on mileage features from the telematics data, which are used to assign the mileage distribution to different driving contexts, where contexts may be combinations of relevant factors; for instance: rain, daytime, highway: 100 kilometers; rain, night, alley: 50 kilometers. The cognitive risk identification program 110A, 110B then may produce a claim ratio of a claim by normalizing a claim by mileage, for instance 1.2 times claim/mileage for a rainy night. In some embodiments, cognitive risk identification program 110A, 110B may use environmental risk factors from the road network and weather data and claims data to evaluate driving habits and the driver profile in assessing risk; the environment risk feature pattern demonstrates the environment's impact on risk, which could be used as a base for more accurate trip level driving scoring and guide driver's behavior optimization. In other embodiments, different regional risk features abstracted from the claim-enriched data may demonstrate different risk characteristics of geographical regions, which could support better regional risk evaluation and policy localization.

It may be appreciated that FIG. 2 provides only an illustration of one implementation and does not imply any limitations with regard to how different embodiments may be implemented. Many modifications to the depicted environments may be made based on design and implementation requirements.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302a,b and external components 304a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the cognitive risk identification program 110A in the client computing device 102, and the cognitive risk identification program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the cognitive risk identification program 110A, 110B, can be stored on one or more of the respective portable computer-readable tangible storage devices 338, read via the respective R/W drive or interface 332, and loaded into the respective hard drive 330.

Each set of internal components 302a,b also includes network adapters or interfaces 336 such as a TCP/IP adapter cards, wireless Wi-Fi interface cards, or 3G or 4G wireless interface cards or other wired or wireless communication links. The software program 108 and the cognitive risk identification program 110A in the client computing device 102 and the cognitive risk identification program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the cognitive risk identification program 110A in the client computing device 102 and the cognitive risk identification program 110B in the server 112 are loaded into the respective hard drive 330. The network may comprise copper wires, optical fibers, wireless transmission, routers, firewalls, switches, gateway computers and/or edge servers.

Each of the sets of external components 304a,b can include a computer display monitor 344, a keyboard 342, and a computer mouse 334. External components 304a,b can also include touch screens, virtual keyboards, touch pads, pointing devices, and other human interface devices. Each of the sets of internal components 302a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

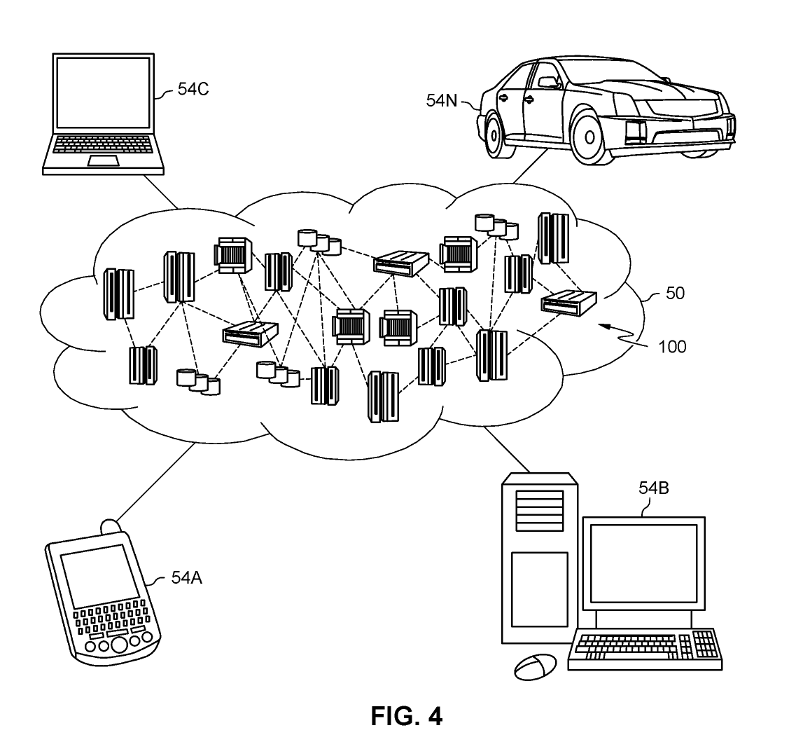

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

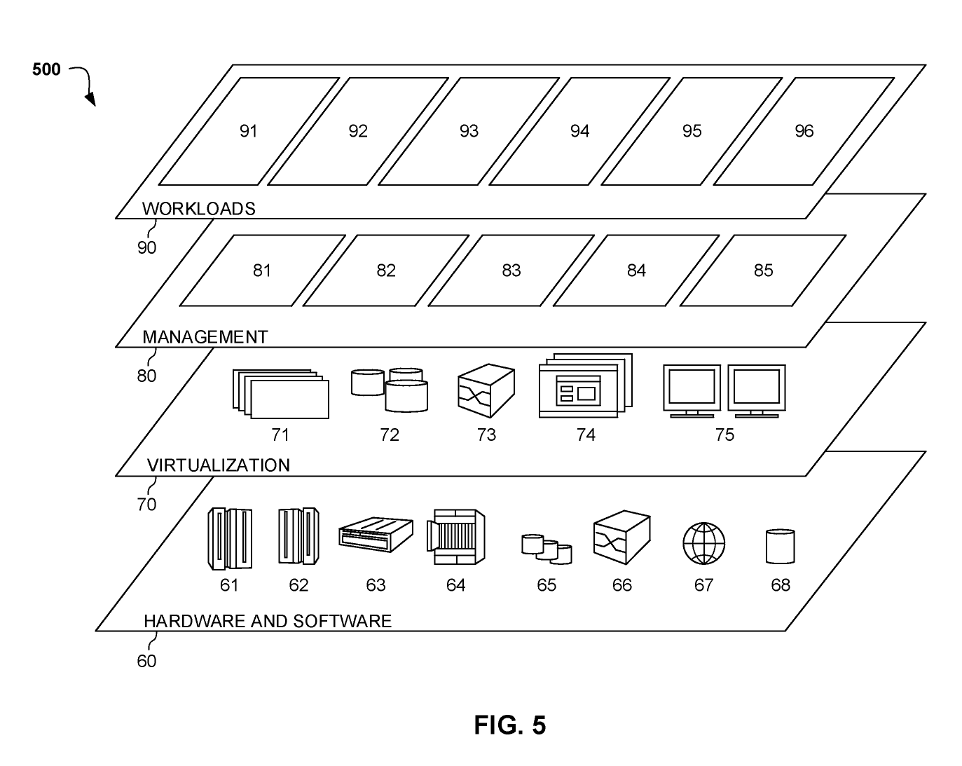

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive risk assessment 96. Cognitive risk assessment 96 may relate to using telematics data from connected vehicles, as well as road network, weather, and historical claims data to derive a contextual customer profile representing customer behavior in a real world environment, and the risks associated with such behavior.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for assessing driving risk associated with one or more drivers, the method comprising:
receiving a plurality of telematics data, a plurality of road network data, a plurality of weather data, and a plurality of historical claims data;
generating one or more customer behavior profiles based on the plurality of telematics data, the plurality of road network data, and the plurality of weather data;
training, using the plurality of historical claims data and one or more features of the one or more customer behavior profiles, a risk scoring engine; and
producing an assessment of a risk of loss posed by one or more drivers.

2. The method of claim 1, wherein the risk scoring engine is a cognitive system that uses machine learning to improve an output accuracy as an amount or a quality of available training data increases.

3. The method of claim 1, wherein the risk scoring engine employs a mathematical model selected from a group consisting of a statistical linear regression model, a regression network, a classification network of deep learning models, and a classification model in machine learning technologies.

4. The method of claim 1, further comprising:
generating a confidence level of the assessment of the risk of loss.

5. The method of claim 1, wherein the assessment of the risk of loss comprises one or more claim ratios, wherein a claim ratio is a ratio of a number of claims to a risk exposure.

6. The method of claim 1, further comprising:
analyzing one or more environmental risk factors from the plurality of road network data, the plurality of weather data or the plurality of claims data to assess an environmental impact on one or more risks posed by one or more drivers.

7. The method of claim 1, wherein one or more regional risk features taken from the plurality of road network data, the plurality of weather data or the plurality of claims data are used to demonstrate one or more risk characteristics of one or more geographical regions.

8. A computer system for assessing driving risk associated with one or more drivers, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a plurality of telematics data, a plurality of road network data, a plurality of weather data, and a plurality of historical claims data;
generating one or more customer behavior profiles based on the plurality of telematics data, the plurality of road network data, and the plurality of weather data;
training, using the plurality of historical claims data and one or more features of the one or more customer behavior profiles, a risk scoring engine; and
producing an assessment of a risk of loss posed by one or more drivers.

9. The computer system of claim 8, wherein the risk scoring engine is a cognitive system that uses machine learning to improve an output accuracy as an amount or a quality of available training data increases.

10. The computer system of claim 8, wherein the risk scoring engine employs a mathematical model selected from a group consisting of a statistical linear regression model, a regression network, a classification network of deep learning models, and a classification model in machine learning technologies.

11. The computer system of claim 8, further comprising:
generating a confidence level of the assessment of the risk of loss.

12. The computer system of claim 8, wherein the assessment of the risk of loss comprises one or more claim ratios, wherein a claim ratio is a ratio of a number of claims to a risk exposure.

13. The computer system of claim 8, further comprising:
analyzing one or more environmental risk factors from the plurality of road network data, the plurality of weather data or the plurality of claims data to assess an environmental impact on one or more risks posed by one or more drivers.

14. The computer system of claim 8, wherein one or more regional risk features taken from the plurality of road network data, the plurality of weather data or the plurality of claims data are used to demonstrate one or more risk characteristics of one or more geographical regions.

15. A computer program product for assessing driving risk associated with one or more drivers, the computer program product comprising:
one or more computer-readable tangible storage medium and program instructions stored on at least one of the one or more tangible storage medium, the program instructions executable by a processor to cause the processor to perform a method comprising:
receiving a plurality of telematics data, a plurality of road network data, a plurality of weather data, and a plurality of historical claims data;
generating one or more customer behavior profiles based on the plurality of telematics data, the plurality of road network data, and the plurality of weather data;
training, using the plurality of historical claims data and one or more features of the one or more customer behavior profiles, a risk scoring engine; and
producing an assessment of a risk of loss posed by one or more drivers.

16. The computer program product of claim 15, wherein the risk scoring engine is a cognitive system that uses machine learning to improve an output accuracy as an amount or a quality of available training data increases.

17. The computer program product of claim 15, wherein the risk scoring engine employs a mathematical model selected from a group consisting of a statistical linear regression model, a regression network, a classification network of deep learning models, and a classification model in machine learning technologies.

18. The computer program product of claim 15, further comprising:
generating a confidence level of the assessment of the risk of loss.

19. The computer program product of claim 15, wherein the assessment of the risk of loss comprises one or more claim ratios, wherein a claim ratio is a ratio of a number of claims to a risk exposure.

20. The computer program product of claim 15, further comprising:
analyzing one or more environmental risk factors from the plurality of road network data, the plurality of weather data or the plurality of claims data to assess an environmental impact on one or more risks posed by one or more drivers.
